(19) United States
(12) Patent Application Publication
(10) Pub. No.: US 2008/0227384 A1
(43) Pub. Date: Sep. 18, 2008

(54) WIRELESS PC TO AUDIO VISUAL LINK ASSEMBLY FOR A MOTION VIDEO DISTRIBUTION SYSTEM

(75) Inventors: Rolf Uwe Placzek, Dubendorf (CH); Frank J. Hoffmann, Goerwihl (DE); Leslie Goldng, London (GB); Ralph Karliczek, Gmund (DE)

Correspondence Address: MOETTELI & ASSOCIATES SARL, ST. LEONHARDSTRASSE 4, ST. GALLEN, CH-9000, CH

(73) Assignee: Acetrax Operations AG, Thalwil-Zurich (CH)

(21) Appl. No.: 11/759,987

(22) Filed: Jun. 8, 2007

Related U.S. Application Data
(60) Provisional application No. 60/864,763, filed on Nov. 7, 2006.

(51) Int. Cl. H04H 60/09

(52) U.S. Cl. 455/3.06

(57) ABSTRACT

A wireless PC-to-TV Audio/Visual (A/V) link assembly for a video content distribution system is provided. The link assembly includes a symbiotic adapter, a wireless receiver, and a remote control. The symbiot has a control circuit including a data storage media, a remote control interface, a wireless A/V transmitter for transmitting video content, a PC-interface adapted to communicate with a connectivity enabled host-PC and, through the host-PC connected to a distributed network, with the video content distribution system. The storage media is encoded with an instruction set including a logical routine which upon establishment of communication between the host-PC and the symbiot determines whether dedicated content and access management software is installed on the PC and if not, the logical routine initiates an install application adapted to install the dedicated content and access management software on the host-PC. The wireless receiver is adapted to connect in functional communication with a video display and/or sound system and receive video transmitted by the wireless A/V transmitter of the symbiot and pass the video content on to the display device. The remote control has a user interface, is in functional communication with the wireless receiver and pass command signals on to the symbiot and is adapted to enable a user to remotely control operation of the symbiot, the wireless receiver and the content and access management software.

### CROSS REFERENCE TO RELATED APPLICATIONS

This application will claim priority to and incorporate by reference the contents of U.S. Provisional application Ser. No. 60/864,763 filed Nov. 7, 2006. Title: BROADBAND ISP CONTENT MANAGEMENT SYSTEM.

### FIELD OF THE INVENTION

The present invention is in the field of interactive multimedia content distribution systems. Specifically, the present invention relates to the unidirectional distribution of motion video, text, or image data and accompanying audio in which the user interaction via a dedicated user interface is occasional or intermittent in nature. More specifically, the present invention relates to the client-side system that facilitates the user's intermittent interaction with the multimedia content distribution system.

### BACKGROUND OF THE INVENTION

It is known to use a set-top box 10 connected to a router 12, to control access to, selection and display of digital media content on a display device 14, for home entertainment (see FIG. 1).

Where broadband connections 16 (greater than 2 mega bytes per second) are made inside a home 18, typically, a workstation PC 20 is connected (via a cat5 cable 22 or wireless connection 24) to a router 12 which is in turn connected via a broadband connection 16 to the high speed Internet. The set top box 10 is most recently a PVR (Personal Video Recorder) 10, a set-top box that stores up to 30 hours of TV programming and works with cable and satellite systems. With a PVR, viewers can pause or rewind live TV shows, record a season's worth of episodes, and skip past commercials. The set top box 10 is connected via a bus to the router 12, for content selection and delivery to, typically, a widescreen TV 14 inside the home 18 (see FIG. 2). In addition, a set top box 10 typically provides exclusive access to some type of content, either by enabling a connection to a specific distribution system (IPTV) or by decoding an otherwise encrypted broadcasted signal.

A set-top box 10 or PVR is an additional cost, occupies additional table or shelve space, includes hardware that must be upgraded, and is another point of potential technical failure in the complex task of the management and delivery of real time, streaming content.

The term “set-top box” (STB) is used to describe an interface device installed between (typically) a television and some external source of audio and video signals. The video signal from various external sources can be very different in their characteristics from each other and from the signal requirement of the television display. The STB includes processing circuitry which processes the different external source video signals to make them compatible with input requirements of the television so that the content carried by the signal can be displayed on the video screen. Additionally, the STB processes the audio portion of the signal from the various external sources so that the audio and video signal outputs from the STB are synchronized. The STB also handles remote commands, determining processing preferences.

Historically, before the general availability of cable-ready TV sets, a set-top box known as a cable converter box was used to receive analog cable TV channels signals from A/V content providers, and convert the signals to video (and audio) that could be seen on a regular TV (e.g., channel 3 or 4 in North America, or channel 36 or 37 in the UK). Currently, STBs are boxes are used to descramble premium A/V signals from content providers (e.g., via external sources such as cable, satellite, etc.) for presentation on a TV type display. There are many different external A/V signal sources from which video content can be derived. These include: an ethernet cable, a satellite dish, a coaxial cable, a telephone line, a power line, an RF antenna. Video content can encompass any and all of types of A/V, including Internet webpages, interactive games, IPTV, and modalities yet to be discovered and made available.

An example of a current STB system is described in US Patent Application Publication No. 2007/0118855. The described STB includes a programmable client system and a display device. As previously as previously noted, the STB may be a cable box, a satellite receiver, a VCR, a DVR, or any combination of the like. The STB is connected to the display device, which may be a high definition television (HDTV), a standard television, a flat panel display, a projection device, a computer monitor, or any other device capable of displaying television video content. These current STBs include storage means (e.g., a hard disk or other magnetic media, optical or non-volatile memory means that is capable of storing data. The storage media is used to store event information, program guide data, programming data, A/V content, etc. for access and retrieval by the client/end user. Current STBs are typically bi-directional and usually are always “on.” The STB of the '855 publication includes a server that also sends or serves data in addition to receiving programming content. All A/V signal processing, such as un-scrambling and decoding of the channel or video stream, occurs in the STB.

It is clear that the field is currently motivated to provide STBs with features that are increasingly more hardware, processing power and memory capacity intensive to address an ever increasing range of functionality and input modalities. However, the original purpose of the STB still remains—to provide A/V content to a “television” display device. As can be expected, the cost and complexity of current STBs has increased concomitantly with the industry's efforts to provide the currently desired features.

The need for such a device is strongly motivated by the high entry barriers caused by the required complexity, expanded features and processing power of STBs serving today's market. The high costs of such devices are at least in part underwritten by content providers and passed on to consumers. This constrains IPTV providers into a more limited business model and smaller market than if this cost was lower. In order to lower the cost of entry barriers for consumers, content providers subsidize the required hardware. Although this lowers the cost barrier sufficiently for some consumers to enter the market, the costs are passed on to consumers over time, typically by long contract terms and monthly basic fees. However, if the cost to consumers of both entering and remaining in the market is lower, the consumer market for such content provider will be greater that otherwise, and the business model improved. Currently, the IPTV service industry and associated technologies are still new and not well understood by consumers. So, as long as entry barriers, such as cost of increasingly more complex STBs to access features, monthly fees and long term service contracts are required of consumers, growth of the industry is uncertain.

Clearly, a problem for the industry is how to lower the entry and the utilization costs for consumers, while still providing the desired content and feature-rich capabilities available in current STB-based A/V content distribution systems. A solution to this problem is to reduce or eliminate the need to provide and subsidize client-side hardware required by the distribution system. Specifically, this translates to reducing or eliminating the need to provide and subsidize an STB at the client-side location of the distribution system. Less expansive end-user premises equipment can therefore be a key to opening up a completely new market approach and content provisioning model. Given that the client-side equipment cost reaches a price point where the provider can avoid its subsidization, the cost entry barrier can be lowered to nearly zero, and the ongoing utilization cost goes down as well. This enables use of a business model in this field where the consumer can get client-side hardware for free (or little cost), has no monthly subscription fee and only pays for actual usage of the provider's A/V content and services. This opens up the door for the industry to the mass market for IPTV providers, who currently have to handle the equipment issue from their marketing budgets and otherwise have to bind huge sums of money to subsidized client-side hardware.

Therefore, it would be beneficial to the field to have an alternative to the current STB-based client-side system that is as feature-rich and user-friendly, but which is not as hardware and processing power intensive, nor as complex. It would be beneficial to the field if an alternative feature rich video content distribution system were available to enable IPTV provide A/V content to a television display device, as does a current STB-based system, but without the cost and complexity of a current STB. It would be a further benefit to provide such a feature rich video content distribution system were the cost of functions provided by the STB is substantially reduced or eliminated as an entry cost and use barrier.

### SUMMARY OF THE INVENTION

A wireless PC-to-TV Audio/Visual (A/V) link assembly for a multimedia content distribution system is provided. The present ISP based video content distribution system (e.g., an IPTV service provider and associated network) solves the above problem in the industry by eliminating the hardware based features and processing requirement of any system hardware (the STB) at the client-side of the distribution system. Instead, the present ISP based video content distribution system utilizes existing hardware already present in broadband enabled households—the household's existing personal computer. The present client-side PC-to-AV link assembly is a relatively inexpensive “smart cable” that adapts an existing client-side personal computer to provide all of the feature-rich functionality and processing power currently desired by end-users, and eliminated the need to install an expensive or provider subsidized STB.

The link assembly includes a symbiotic adapter, a wireless receiver, and a remote control. The symbiot has a control circuit including a data storage media, a remote control interface, an audio processor, a video processor, a wireless transmitter for transmitting multimedia content such as text, images, video & audio content, a PC-interface adapted to communicate with a connectivity enabled host-PC and, through the host-PC connected to a distributed network, with the video content distribution system. The symbiot has a DVD-T receiver for receiving broadcast television signals. The storage media is encoded with an instruction set including a logical routine which upon establishment of communication between the host-PC and the symbiot determines whether dedicated content access and management software is installed on the PC and if not, the logical routine initiates an install application adapted to install the dedicated content access and management software on the host-PC. The wireless receiver is adapted to connect in functional communication with a video display and/or sound system and receive audio/video transmitted by the wireless A/V transmitter of the symbiot and pass the content on to a target device such as a TV. The remote control has a user interface, is in functional communication with the remote receiver of the wireless receiver unit passing commands through the symbiot's remote control interface on to the content access and management software, or directly to any devices in between. It is adapted to enable a user to remotely control operation of the symbiot, the wireless receiver or the content access & management software.

In an advantage, the link assembly is symbiotic in that it must be linked to a PC in order to have the processing resources necessary to deliver the content from the multimedia content distribution system, thereby setting up a viral distribution opportunity for the content access & management software and linked to it the whole solution.

In another advantage, the link assembly is simpler and less costly that set top boxes of the prior art.

In another advantage, the cost reductions realized make for a compelling purchase impulse, in that a subscriber need not pay or subsidize expensive hardware and therefore may pay as they use the link system on a per movie basis.

In another advantage, the invention is a PC application that is a centrally managed platform which enables the consumer to access an online purchase universe (e.g. movie shop, merchandise shop, links to other c-shops, links to free content). via a novel marketing logic build into the user flow and applying customer relations management rules.

In another advantage, the invention facilitates billing/transaction recording for e-purchase, by operating servers, which exchange the respective information in a secure way with the PC application.

In another advantage, the invention is a distribution platform, with delivery servers in the IEX (Internet exchange points/Internet backbone junctions), directly peered with ISPs.

In another advantage, the invention provides a wireless link between PC and TV, using the TV as display, and controlling the PC with a wireless remote for the purpose of doing c-commerce. In fact, the PC doesn't need to be in range of the consumer, can even be in another room.

### BRIEF DESCRIPTION OF THE DRAWINGS

FIG. 1 is a schematic diagram of the system of the prior art.

FIG. 2 is a schematic diagram of the system of the prior art installed in a home.

FIG. 3 is a schematic diagram of the system of the invention.

FIG. 4 is a schematic diagram of the system of the invention installed in a home.

FIGS. 5A and 5B are schematic diagrams of the client side software module of the invention.

FIG. 6 is a schematic diagram of the deployment of the system of the invention.

FIG. 7 is a schematic diagram of the link assembly of the invention.

FIG. 8A is a block diagram of the link assembly of the invention.

FIG. 8B is a block diagram of the basic functions of the link assembly of the invention.

FIG. 8C is a more detailed functional block diagram of the link assembly of the invention

FIG. 9A is a perspective view of the symbiotic adapter of the invention̂.

FIG. 9B is a front plan view of the symbiotic adapter of the invention.

FIG. 9C is a top plan view of the symbiotic adapter of the invention.

FIG. 9D is a bottom plan view of the symbiotic adapter of the invention.

FIG. 9E is a rear plan view of the symbiotic adapter of the invention.

FIG. 9F is a schematic view of the tilting antennae assembly of the symbiotic adapter of the invention.

FIG. 10 is a rear plan view of the wireless receiver of the invention.

FIG. 11A is a top plan view of the remote control of the invention.

FIG. 11B is a side plan view of the remote control of the invention.

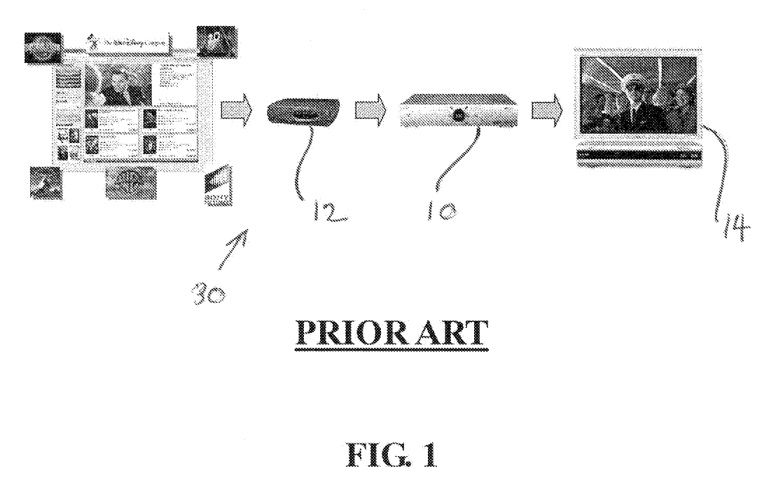

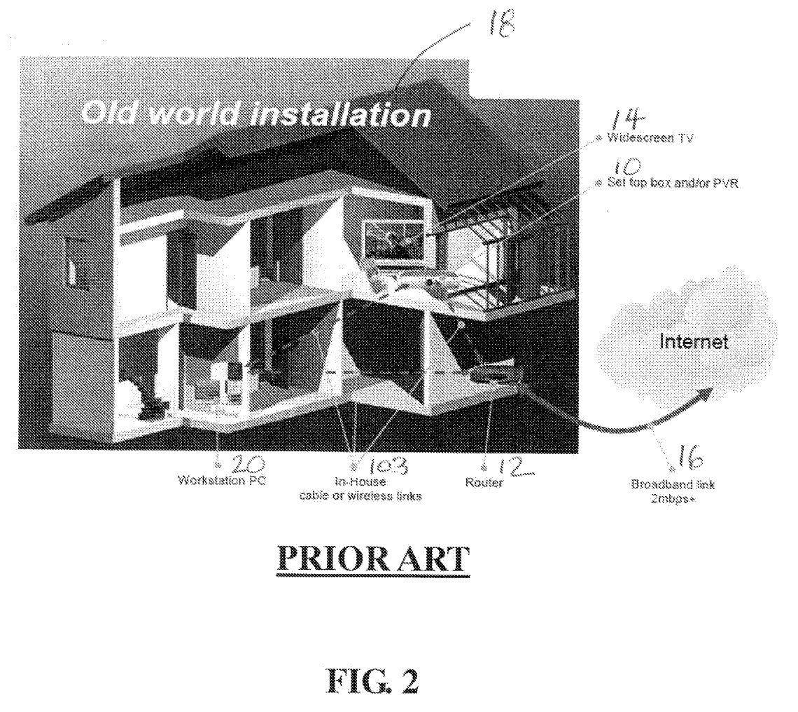

### DETAILED DESCRIPTION OF THE PREFERRED EMBODIMENT

Referring now to the drawings, the details of preferred embodiments of the present invention are graphically and schematically illustrated. Like elements in the drawings are represented by like numbers, and any similar elements are represented by like numbers with a different lower case letter suffix.

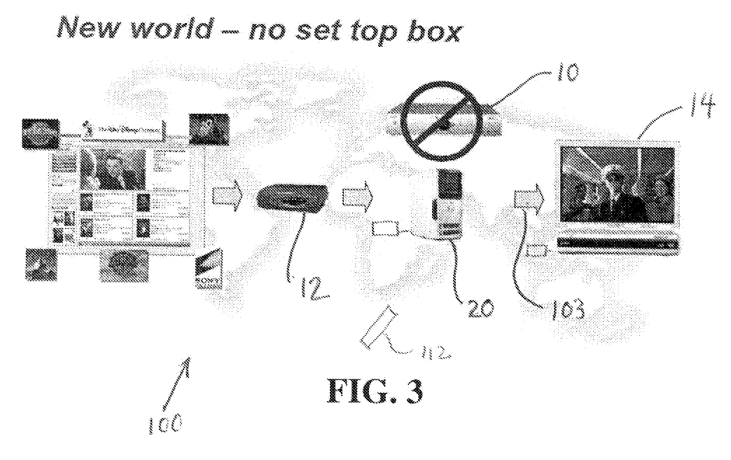

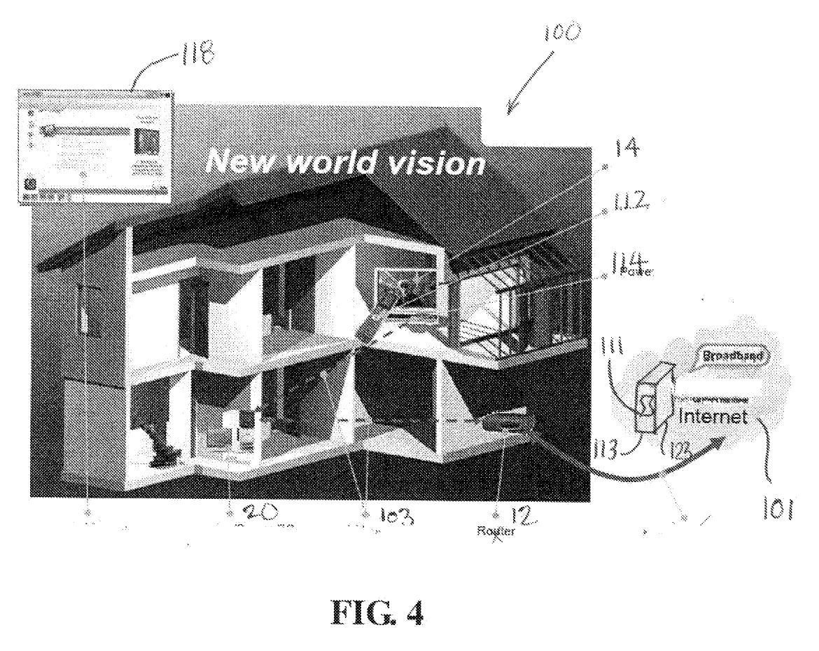

Referring now to FIGS. 3, 4, 5A-5B and 6A and 6B, a content and access management system 100 provides broadband content and access management, processing and distribution that connects the personal computer 20 by which a user accesses the broadband Internet 101 directly with the home entertainment system 14, without having to pass through a set-top box 10. In other words, the computer 20 performs the functions normally carried out by the set-top box 10. The system 100 provides real-time, delivery of digital medium from the PC 20 directly to the home television or entertainment system 14 via a wireless link 103. The content stream includes third party marketing information, driven to the user based on the likelihood of the user's interest in the products and services offered. In this manner, the system 100 provides a fully licensed dedicated turnkey movie/e-commerce shop to allow ISPs to offer Video on demand (VOD) direct to its subscribers.

The system 100 of the invention comprises a software component 105, which is the purveyors' client side content and access management software, and hardware, namely a symbiotic adapter 107 on which software and firmware operates to auto-install web-downloadable software on the host computer 20. ASP software 111 runs on a remote server 113 and controls the processor-intensive tasks based on orders received from the client-side module 105 operating on the user's personal computer 20. Communications there between are secure and encrypted, in order to protect the confidential use data of the user and to prevent interception of the proprietary content being delivered to the user. In this manner, a shared platform 115 is provided for all customers, with a central repository 117. Delivery headends are placed in Internet Exchange Points (IEX) and peers directly (on-net) with the ISP's network, who peers into the respective IEX

The system 100 uses state of the art Sun technology, such as Q1 2007 released Sun server technology enabling viewers to watch a movie on TV streamed live over ADSL (2 mbp/s) while at the same time, downloading in the background. In this way, HD (high definition) movies can be optionally downloaded.

The system 100 includes a source 125 of video content stored on a readily accessible database 127, the client side software 105 operating on the user's PC 20, a radio remote control 112, and a Plug and play PC-to-A/V link 114 to the TV.

Note that the client side software 105 is dedicated to content and access management and provides a user with access to an online purchase universe which includes movie shops, content-related merchandise shops, links to other e-shops, and links to free content, such being centrally managed and facilitated by the purveyors of the system.

The system 100 optionally includes a recommendation engine 123. The recommendation engine 123 permits cross selling related digital media (e.g. mobile asset) and merchandise. The recommendation engine 123 relates top selling titles in similar genre, actor and profiles the user so as to suggest similar purchases to the user which are not limited to movies, but include any consumer product or service.

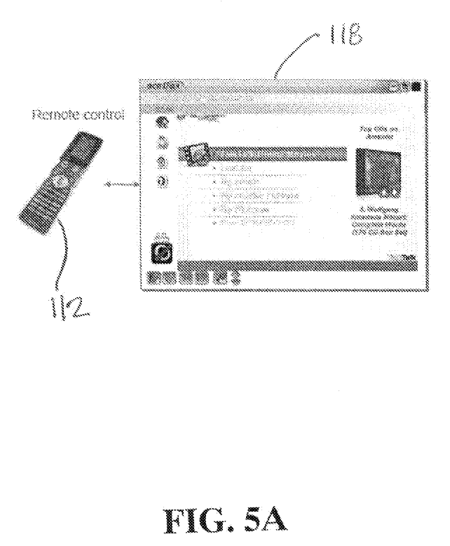

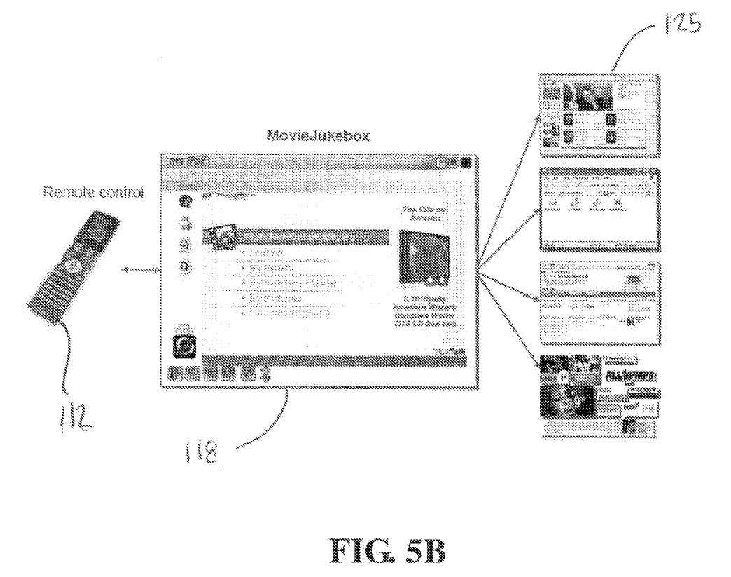

Referring in particular to FIGS. 5A-5B, the client side software module 105 (also referred to as the Music/Movie Jukebox module) of the system 100 of the invention includes a dedicated user interface 118 to the purveyor's backend system (not shown) for legal premium movie delivery. This module 110 provides selection features, such as genres, search, suggestions, premium and free movie content. Further, user authentication is initiated when user wishes to make a purchase, which can be performed using a remote control device 112 by inputting a numerical ID in the user remote control 112.

The Client side software module 110 also provides select and pay features, by the push of a button 122 on the remote 112, and enables integrated billing on the ISP's bill to their customer via various Application Service Provider models, such as Pay-Per-Use, time-based payment, subscriptions, or function-based payment. Alternatively, the purveyor's billing information is transmitted via a known format, such as Excel, formatted in a secured manner agreed to by the purveyors and the ISP. Such invoices can be settled internally between the ISP and the purveyors. A billing and reporting module 124 of the Client side software PC module 110 has a billing interface (to the ISP or to another online billing platform), operating in the backend 120 in which the charges appear on the ISP bill or come via another means.

The graphical user interface 118 is provided to permit the user to view and manipulate a streamed application's status.

Still further, the client side software module 110 is able to play streaming content such as WMV (VC-1) movies with MS DRM 10, and MPEG-4H.264 movies with Verimatrix DRM. This module also provides command functions to download movies and related content.

The client side software Module 110 also pushes suggested content to the user, via selections by the portal manager. For example, the top 10 movies or hits of the week, or season, may be suggested. Preferrably, the module displays a “Teaser Frame” on the display device, presenting short clips of movies which can be immediately accessed and purchased.

Preferrably, according to the purveyor's business model, the Client side software 110 is <<white labelled>> and so is rebranded according to the purveyor's customer's corporate identity. The module enables the user to specify how related content and merchandise is presented. The software of the invention operates on the PC to enable the user to access an online purchase universe which include movie shops, content-related merchandise shops, links to other e-shops, and links to free content, that is centrally managed and facilitated by the purveyors of the system.

Referring now to FIG. 7, 8A and 8B, the plug and play PC-to-A/V link 114 to the TV 14 includes, on the one hand, the symbiot 107 having a USB hub 128 that connects to a USB port 128′ and a VGA port 132 that connects to the VGA output port 132′ of the PC 20, and a wireless receiver 140 connected to a presentation device 14, for transmission and reception of control signals from the remote control 112, and transmitting multimedia output from the PC to the TV 14 and/or sound system 15. The connection of the wireless receiver 140 to the display device 14 may be accomplished via a SCART connector, an optical S/PDIF, a stereo CINCH, an FP/dif coaxial, optical connector, jacks or other known means.

In a preferred embodiment, shown, the link system 114 is “wireless” in that the communications between the link system 114 and the elements which it connects, namely, the PC 20 and the TV 14 takes place over a wireless communications channel or an A/V powerline connection linked via the power supply of the symbiot 107 and wireless receiver 140.

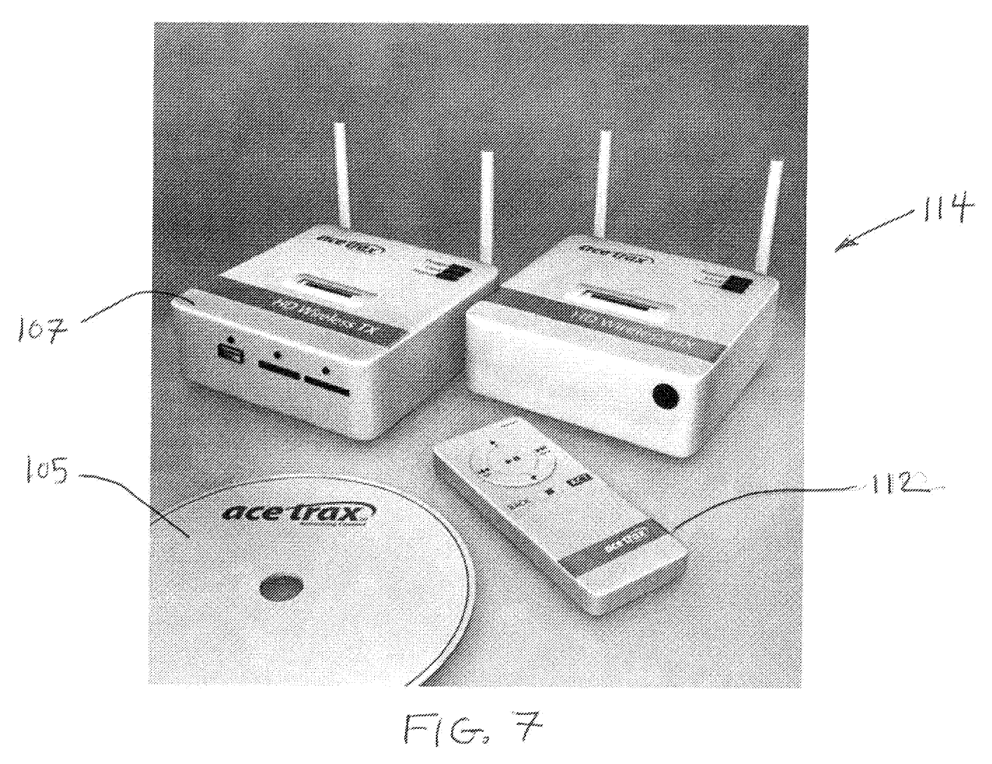

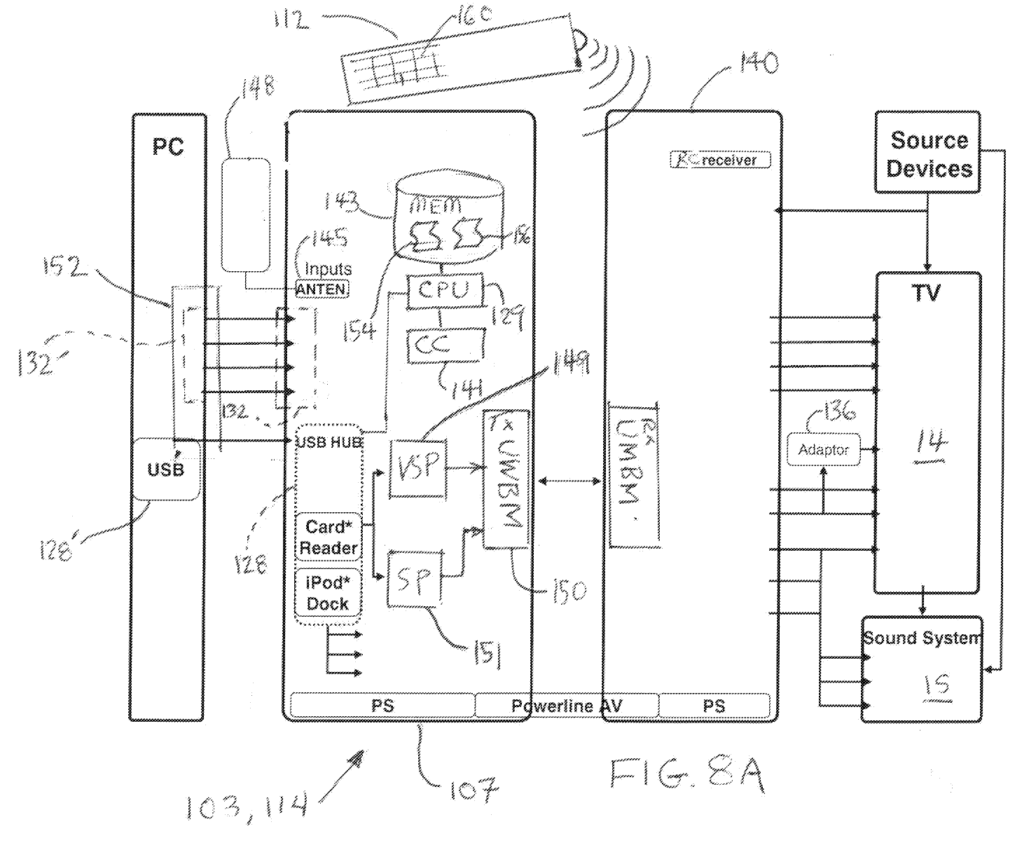

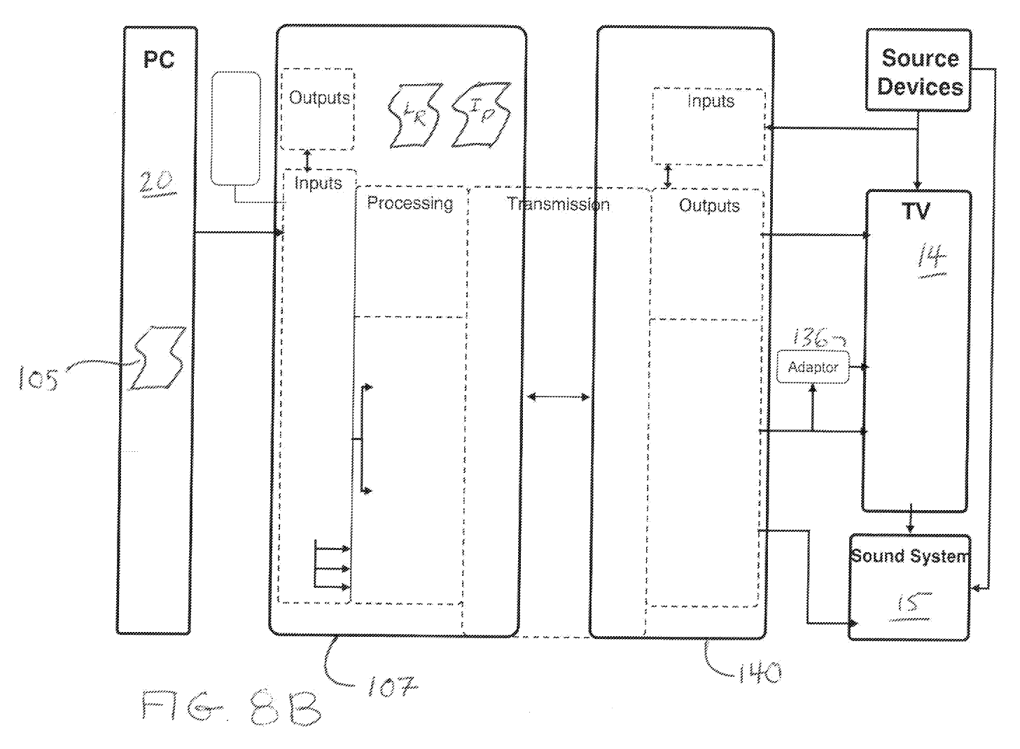

Referring in particular to FIGS. 8A to 8C, the wireless PC-to-TV Audio/Visual (A/V) link assembly 114 includes the symbiot 107, a wireless receiver 140, and the remote control 112. The symbiot 107 has a control circuit 141 including a data storage media 143, a remote control interface 145, an integrated DVB-T receiver 147, with an antennae 148, a video processor 151, an audio processor, a wireless transmitter 150 for transmitting video content, a PC-interface 152 adapted to communicate with a connectivity enabled host-PC 20 and, through the host-PC connected to a distributed network such as the Internet 101, with the video content distribution system 125. The symbiotic 107 adapts audio video formats for transmission and when adapted, passes them over to a chip set that either passes them through as is, or encodes them for the transmission itself (correction coded, etc.). The PC interface 152 may be an active USB hub 128. The interface 152 may include a card reader 153 and a proprietary media interface 155 such as an iPod™ dock or other MP3 player interface. The symbiot 107 can receive electrical power through an external power supply (not shown) or optionally, at least a portion of the power required can be obtained via the USB connection to the PC thus allowing the symbiot to symbiotically use the PC power for at least the auto-install functions of the symbiot. The storage media 143 is encoded with an instruction set including a logical routine 154 which upon establishment of communication between the host-PC 20 and the symbiot 107 determines whether dedicated client side software 105 is installed on the PC and if not, the logical routine initiates an install program 156 adapted to install the dedicated client side software 105 on the host-PC. The installed software 105 then uses the resources of the PC 20 to operate therewith in a symbiotic manner, pushing resource intensive processing to the PC and thus reducing the cost and complexity of the system 100.

The remote control 112 has a user interface 160, is in functional communication with the remote receiver of the wireless receiver passing through commands to the remote control interface of the symbiot 107 and is adapted to enable a user to remotely control operation of the symbiot, the wireless receiver and the content access and management software 105.

The link assembly 114 controls the conversion of different A/V signals to a format compatible with the video display 14 and sound system 15, such video signal processing taking place in either the symbiot 107 or the wireless receiver unit 140. In addition, the link assembly 114 controls video parameter setup (scaling, positioning, color adaptation, sharpness, hue, flicker, contrast, brightness) and audio parameter setup (stereo and 5.1 surround sound, such as DTS, THX, Dolby Pro Logic I/II).

Optionally, the A/V interface is integrated with the symbiot 107 and the A/V interface includes a second interconnect cable means to accomplish the second communications link between the symbiot and the video display and sound system.

Further, the PC-interface of the symbiot 107 includes a video conversion circuit and an audio processing circuit. The video conversion circuit receives a conditioned video signal from the host-PC. The video conversion circuit converts the conditioned video signal as appropriate for communication to the A/V-interface. The audio processing circuit receives a conditioned audio signal from the host-PC, the audio processing circuit functioning as an additional external sound card adapted to convert the conditioned audio signal as appropriate for communication to the A/V-interface.

Note that as referred to herein, a “conditioned” audio or video signal is a signal received from an external source (a CD, DVD, telephone line, internet) which becomes “conditioned” as it is processed in the PC (e.g., analogue converted to digital) for output on an I/O port, like a USB port.

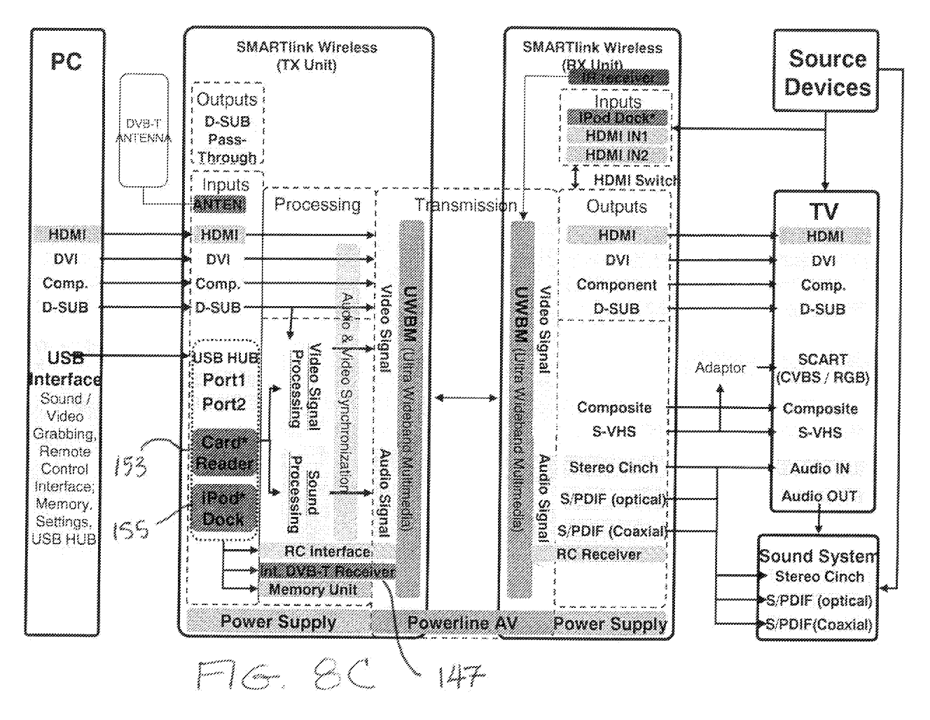

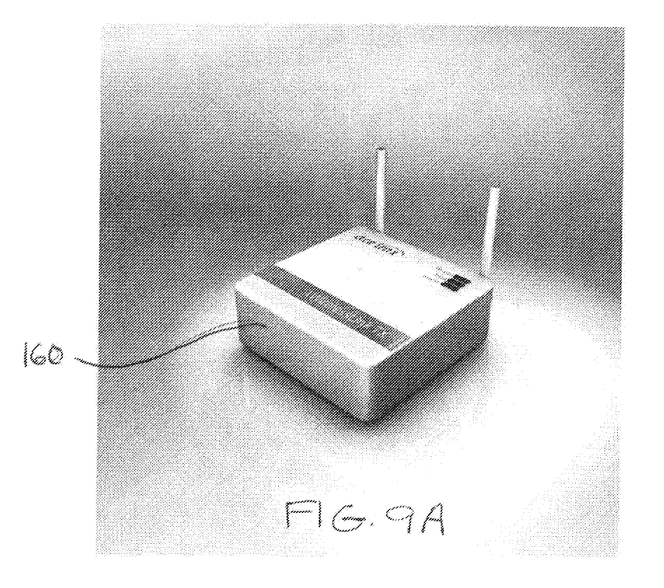

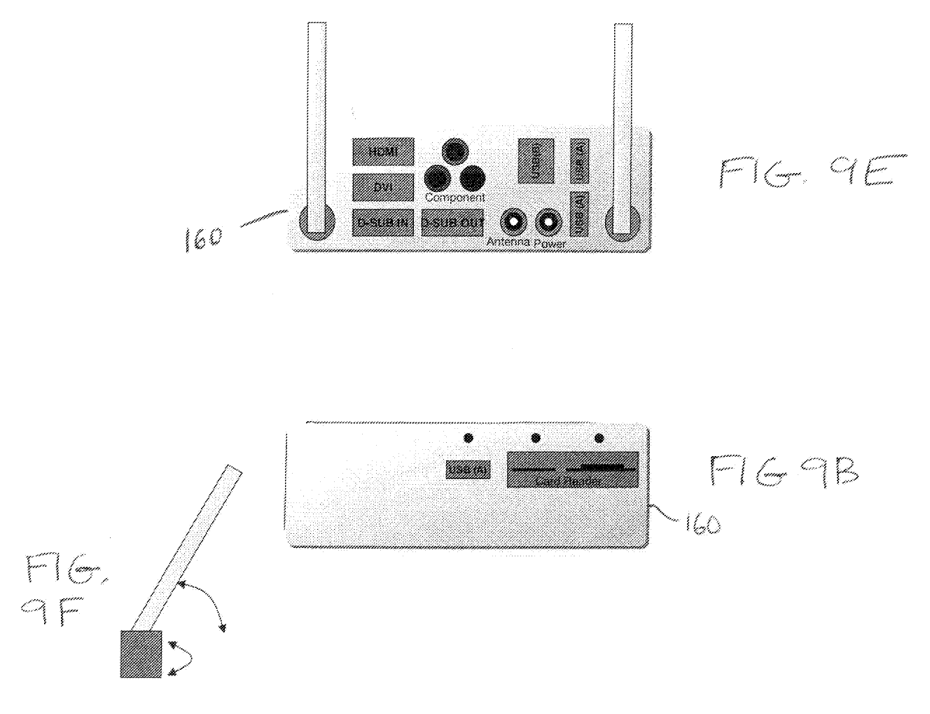

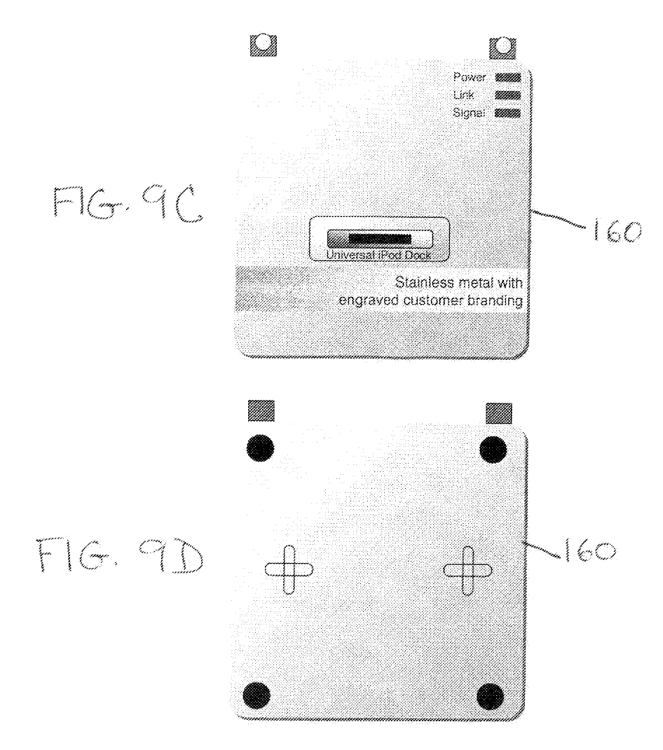

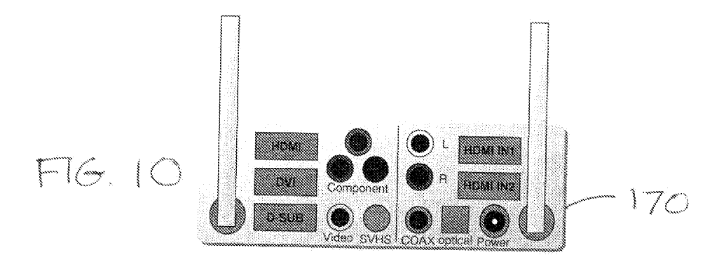

Referring now to FIGS. 9A to 9F, the symbiotic adapter 107 of the invention is enclosed in an elegant housing 160 outfitted with a connector set.

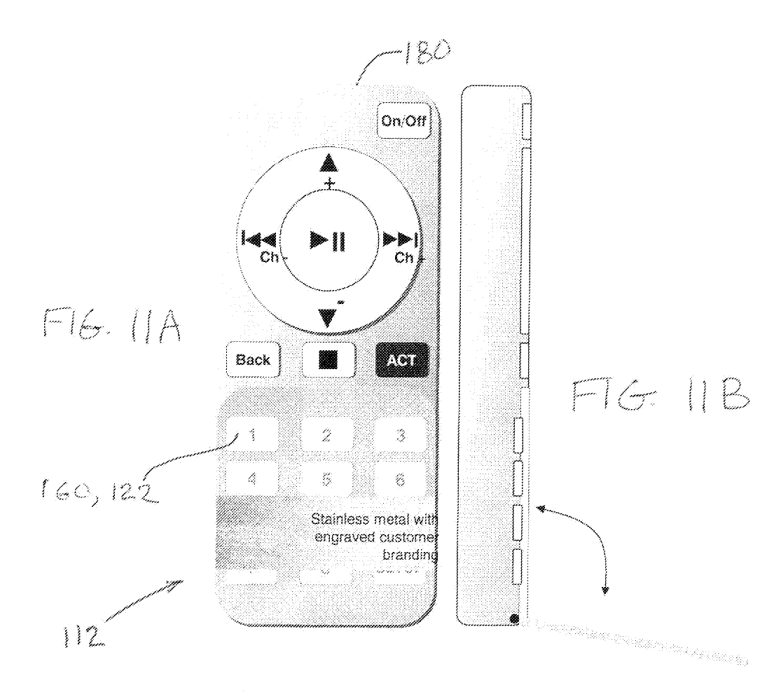

Referring now to FIG. 10, the wireless receiver 140 is packaged in a simple yet elegant housing 170.

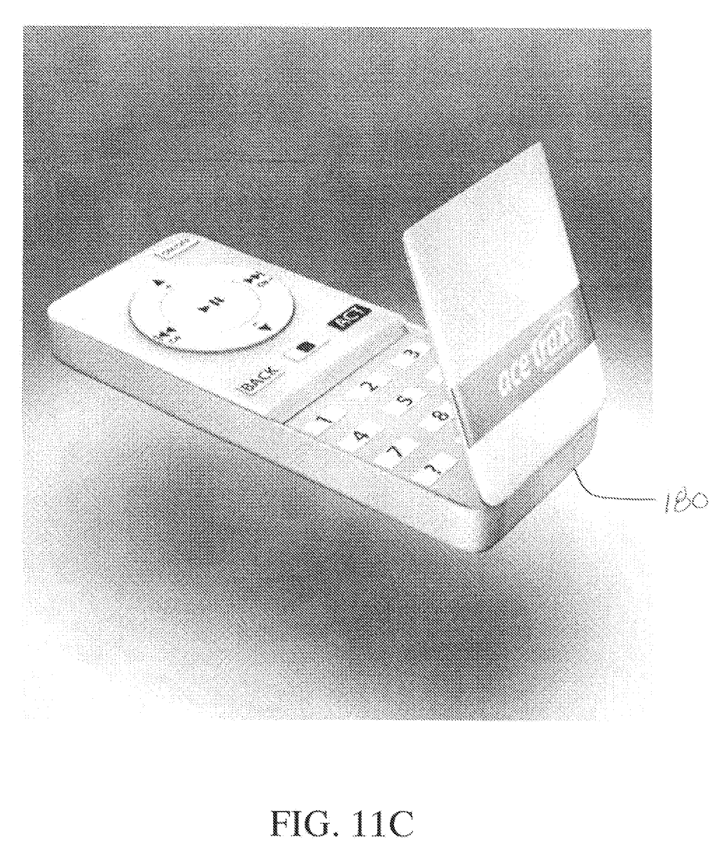

Referring now to FIG. 11A, the remote control 112 of the invention is packaged in a corresponding housing 180.

The connectivity enabled host-PC 20 is able to selectably link with a plurality of external devices, programs and systems and import data in many different formats therefrom. As used herein, connectivity means the capability of the host-PC to attach to the external devices, programs and systems without further modification.

The system centrally facilitates billing/transaction recording for c-purchase, by operating servers and controlling the exchange of the required information in a secure way between the PC application and the client ISP's billing system via the application program interface of the client ISP's billing software.

The recommendations of the recommendation engine may be generic, based on user profiling, or may be specific to the media being streamed to the user. The recommendation engine recommends movies based on a previously selected choice or user profiling. An appropriate recommendation engine can be selected among those described in U.S. Pat. No. 7,113,917, entitled “Personalized recommendations of items represented within a database”, U.S. Pat. No. 7,075,000 entitled “System and method for prediction of musical preference”, U.S. Pat. No. 6,412,012 entitled “System, method, and article of manufacture for making a compatibility-aware recommendations to a user”, and U.S. Pat. No. 6,064,980, entitled “System and methods for collaborative recommendations”, the contents of which, to the extent compatible herewith, are incorporated herein by reference thereto. Further, merchandising is facilitated based on the selected movie, video or song, thereby offering related physical goods such as caps, t-shirts, glasses etc. at the point of hightened user interest, thereby promoting sales.

The radio remote control of the system controls all functions (incl. “Play”, “Stop”, “Pause >>. The Plug and play link to the TV may be connected via a cable (S-Video) or be wireless (HDMI). The remote control also provides an interface by which a user can login (via a PIN) to authenticate the user for profiling and to unlock online purchases. The term “remote control” can be also referred to as “remote” or “controller” when abbreviated. It has been known by many other names as well, such as the “clicker,” etc. Commonly, remote controls are used to issue commands from a distance to televisions or other consumer electronics such as stereo systems and DVD players. Remote controls for these devices are usually small wireless handheld objects with an array of buttons for adjusting various settings such as television channel, track number, and volume. In fact, for the majority of modern devices with this kind of control, the remote contains all the function controls while the controlled device itself only has a handful of essential primary controls. Most of these remotes communicate to their respective devices via infrared (IR) signals and a few via radio signals. They are usually powered by small AAA or AA size batteries.

Optionally, using the system of the invention, a user can choose to watch a selected media immediately or to download the selected media for later play. He is able to sideload content (e.g. R-tones, logos) to a mobile device. Further, different movie formats are made available to the user, formatted for different terminal devices (e.g. TV, portable media player, mobile phone).

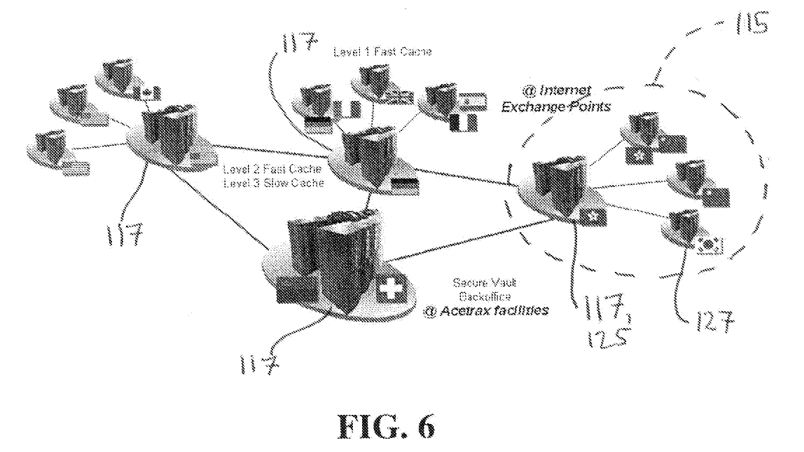

Referring now to FIG. 6, the system 100 of the invention offers a scalable managed platform concept. The sharing of infrastructure results in low-cost access to high quality service.

In an advantage, the system 100 promotes viral distribution of video content via adware that is allowed access to a host PC due to the fact that the symbiot 107 needs a PC 20 to function, the link assembly 107 is portable, unlike a typical settop box 10 or the user's PC, and the fact that the link system is associated with the user's account regardless of the video display device used, thereby allowing a user to carry the light weight link assembly to a home of a friend, connect to that's friends PC, and then initiate an install on the PC of the client side software including its adware and push advertising functionality, while offering the friend the opportunity to view content without being a subscriber to the system. However, because of the requirement of installation of software 105 on the PC 20, the owner of the PC to which the symbiot 107 is installed is likely to subscribe to the service after having tested it <<for free >> using the account of his friend. Further, the symbiotic aspects of the link system 114 mean that the link system can be very inexpensive and therefore, be offered for little or no cost. Consequently, a rapid expansion of the installed base of potential subscribers is promoted.

In another advantage, the system 100 facilitates content licensing and aggregation of all relevant digital output (e.g. Hollywood, Bollywood, local content, TV . . . ). The system 100 connects content to broadband networks. It is most effective when the system 100 is deployed globally, so as to provide a global-scale delivery platform, connected to the key nodes of the Internet backbone and directly connectable (on-net) to ISPs throughout the world.

In another advantage, the system 10 does not require a set-top box 10, but rather uses the user's PC to run control software 105 to manage the system of the invention, which includes the user's PC, TV and broadband connection.

In another advantage, the invention provides an integrated solution for ISPs, including a PC movie jukebox download application, a wireless kit (PC remote, PC VGA+ phono jack to TV Scart plug), an intelligent platform (for cross-selling & profiling—relating to purchase), and including an integrated to CPW billing system

In another advantage, the system of the invention is complimentary to existing Sky, Freeview, free to air TV.

In an advantage, the invention is a PC application is a centrally managed platform which enables the consumer to access an online purchase universe (e.g. movie shop, merchandise shop, links to other e-shops, links to free content).

In another advantage, the invention facilitates billing/transaction recording for e-purchase, by operating servers, which exchange the respective information in a secure way with the PC application.

In another advantage, the system 100 is a distribution platform, with delivery servers in the IEX (Internet exchange points/Internet backbone junctions), directly peered with ISPs.

In another advantage, the system 100 provides a wireless link between PC 20 and TV 14, using the TV as display, and controlling the PC with a wireless remote 112 for the purpose of doing e-commerce.

Multiple variations and modifications are possible in the embodiments of the invention described here. Although certain illustrative embodiments of the invention have been shown and described here, a wide range of modifications, changes, and substitutions is contemplated in the foregoing disclosure. While the above description contains many specifics, these should not be construed as limitations on the scope of the invention, but rather as exemplifications of one or another preferred embodiment thereof. In some instances, some features of the present invention may be employed without a corresponding use of the other features. Accordingly, it is appropriate that the foregoing description be construed broadly and understood as being given by way of illustration and example only, the spirit and scope of the invention being limited only by the description as filed which presents patentable subject matter such description including the appended claims.

### Product Scope:

The “HD Wireless” is a wireless connectivity solution. In combination with an installed Acetrax Client SW on a separate computer or other suitable I qualified source devices it allows the display of a multitude of audio and image/video contents in the home entertainment environment. It is capable to bridge the physical gap between locally separated source devices and a state of the art home entertainment system supporting up to Full HD video resolution (HDMI/DVI with HDCP support)/multi channel audio and customer control protocol (the HDMI includes this includes a passing through a back channel—if connect a dvd player via this to a flat panel tv of the same manufacturer I can use the system remote to control HDMI is bidirection, there is a backchannel to send back) The bundled remote control gives the user full control over the UI and integrated 3^{rd} party applications accessing PC stored, DVB-T and online media contents without the need to stand up from his couch. Qualified source devices can be controlled by this remote too, whereas HDMI connected source devices supporting customer control protocol can be steered by their native remotes.

### Key Feature Set:

Design:
Small and attractive housing including the possibility of wall mounting. With regards to a later positioning as a white label product the housing design is neutral. Customization is enabled by a metal design element dedicated to carry text or graphic elements such as a logo.
Audio connectivity:
When connected by a USB connection to the PC, HD Wireless operates as an additional external sound card transmitting only sound generated by the Acetrax Client SW (subjected to change). If connected to third party source device via HDMI HD Wireless acts as wireless adaptor substituting the cable between source and target device. Audio signals are transmitted as provided by the source and made available on the following connectors on the RX Unit: HDMI, Stereo Chinch, S/PDIF optical and coaxial.
Video Connectivity:
   Variant 1: Video is provided via HDMI, DVI, Component or D-SUB.
   Variant 2: Video is transmitted by a USB 2.0 connection.
The device converts video signals automatically to the required target format PAL(B,D,G,H,I,M,N), NTSC (M) or HD paying regard to the contents format as well as to the target display. The picture setup (scaling, positioning, color adaptation, sharpness, hue, flicker, contrast, brightness) is done automatically. As outputs HDMI, DVI (both including HDCP), Component, D-SUB, Composite and S-VHS are available on the RX unit. Contents requiring a HDCP protection are only transmitted if it is ensured that the encryption is maintained until the target display. Therefore they can only be displayed if the source and target devices are connected to the system by HDMI or DVI (incl. HDCP).
Digital Video Broadcast:
An integrated DVB-T receiver allows the viewing of freely available digital video broadcasts. The dedicated software module is seamlessly integrated into the Acetrax client SW and can be fully controlled using the bundled remote. It offers also all usually expected functionalities of a state of the art DVB-T for PC solution such as hard disk recording (not for online contents).
Remote control:
Based on radio frequency technology it has got a range of 30 m (open field). Its design is fully simplicity orientated offering only 21 keys of which 12 not permanently required could be hidden. The remaining keys are fully sufficient to navigate through the user interface as well as to control media playback or interactive contents. In order to offer a maximum of usability the remote commands are context sensitively interpreted by the UI. If a qualified third party source device is connected to the system it can also be controlled via the bundled remote. In case a third party source device is connected via HDMI and supports CCP (customer control protocol) its IR remote control commands are received by the RX unit and passed through to the device.
Internal memory:
The device's internal memory serves for the storage of user settings such as UI and setup preferences as well as for the storage of a setup routine.
Device Setup:
   Setting up the device in cooperation with a computer:
   Setting up the device is made as simple as possible. After connecting the RX unit to the target devices (TV and sound system) an auto start application is executed as soon as the USB connection between TX unit and computer is established. Recognizing whether the Acetrax client SW is already installed on the system or not it is either started up or a web installer (stored on the devices internal memory) is executed. This installer is downloading and installing the complete Acetrax client SW including latest UI templates and device drivers via internet download. Further it performs the automatic picture/sound setup as well as remote pairing and gives the user the chance for manual optimization. Those preferences can be stored on the devices for a specific home entertainment environment.
   Viral marketing (only relevant if setup with a computer):
   The HD Wireless serves as carrier in the sense of a viral marketing approach. Its transportability allows the user to enjoy online contents in multiple home entertainment environments. (E.g.: Enjoying a football match at a friends place who owns a big screen) After it was installed to a new computer the Acetrax client SW will remain on this computer, still giving the owner access to PC stored and a set of free online content (e.g.: trailers). Presupposed the broadcaster's business model is pay per view and the HD Wireless is distributed for free it is very likely that the user of this infected computer will become a subscriber. Logically he can become so directly via the Acetrax client SW as well order his own device. Also an incentive approach for the infection of new computers could be thinkable. HD Wireless and a computer maintain a symbiotic relationship giving computer stored media contents the reach to be enjoyed where they belong: into the living room!
   Setting the device up as wireless HDMI adaptor:
   If HD Wireless TX unit is connected to a HDMI source device only ist audio and video signal are transmitted to the RX unit from where they are handed to the target devices. The source device can be controlled by the devices original remote control. No setup except connecting and switching on is required.
   Connection to a computer and a HDMI source device:
   In such a case the user can determine via the UI which source he would like to access.
HDMI Switch:
The HD Wireless RX unit has got two additional HDMI in plugs and is acting as a HDMI switch. The user is able to determine which source (local HDMI1, local HDMI2, Wireless HDMI) he would like to activate via the UI/remote control.
Additional media interface on the RX unit:
In order to give direct access to contents stored on USB devices or proprietary media players the RX unit can feature an additional USB plug or a proprietary connector. Content from connected devices can be directly accessed and certain devices maybe controllable by the bundled remote.
Additional interfaces of the TX unit:
The TX unit features two extra USB ports on the backside as well as one on the front side. This enables the connectivity of further USB peripherals such as hard disks or MP3 Players. On the front side an integrated card reader allows the user to manipulate the content of actual storage media used in MP3 players, digital cameras or mobile phones closing the value chain for digital merchandize business. Also a dock for proprietary MP3 players can be integrated on the upper side.
Transmission:
   The signal transmission is bidirectional between the RX and the TX unit. Where the transmission from the TX unit to the RX unit is optimized for Audio Video contents, the backchannel is dedicated for the required exchange of steering signals as well as data transfer concerning UI and content handling. Base Technology for the transmission can either be a suitable radio frequency transmission such as Ultra Wideband Multimedia or a suitable wired transmission such as

What is claimed is:

1. A wireless PC-to-TV Audio/Visual (A/V) link assembly for a multimedia content distribution system, the A/V link assembly comprising:
a symbiot having a control circuit including a data storage media, a remote control interface, an audio processor, a video processor, a wireless transmitter for transmitting multimedia content, PC-interface adapted to communicate with a connectivity enabled host-PC and, through the host-PC connected to a distributed network, with the video content distribution system, wherein the storage media is encoded with an instruction set including a logical routine which upon establishment of communication between the host-PC and the symbiot determines whether dedicated content and access management software is installed on the PC and if not, the logical routine initiates an install application adapted to install the dedicated content and access management software on the host-PC;
a wireless receiver adapted to connect in functional communication with a video display and/or sound system and receive audio/video transmitted by the wireless A/V transmitter of the symbiot and pass the video content on to the display device;
a remote control having a user interface, the remote control in functional communication with the remote receiver of the wireless receiver which passes on commands through the remote control interface of the symbiot on to the content access and management software and adapted to enable a user to remotely control operation of the symbiot, the wireless receiver and the content and access management software.

2. The PC-to-TV Audio/Visual (A/V) link assembly of claim 1, wherein the connectivity enabled host-PC is adapted to selectably link with a plurality of external devices, programs and systems and import data in many different formats therefrom, connectivity being the capability of the host-PC to attach to the external devices, programs and systems without further modification.

3. The PC-to-TV Audio/Visual (A/V) link assembly of claim 1, wherein the symbiot is external to the host-PC, and the PC interface is integrated with the symbiot and the PC interface includes a first interconnect cable means providing a first communications link between the symbiot and an I/O port of the host-PC.

4. The PC-to-TV Audio/Visual (A/V) link assembly of claim 1, wherein the symbiot receives operative electrical power via the first communications link between the symbiot and an I/O port of the host-PC.

5. The PC-to-TV Audio/Visual (A/V) link assembly of claim 1, wherein the symbiot controls the conversion of different A/V signals to a format compatible with the video display and sound system.

6. The PC-to-TV Audio/Visual (A/V) link assembly of claim 5, wherein the symbiot controls the conversion of different A/V signals to a format compatible with the video display and sound system, including video parameter setup (scaling, positioning, color adaptation, sharpness, hue, flicker, contrast, brightness) and audio parameter setup (stereo and 5.1 surround sound, such as DTS, THX, Dolby Pro Logic I/II).

7. The PC-to-TV Audio/Visual (A/V) link assembly of claim 3, wherein the PC interface of the symbiot comprises the first interconnect cable means having a USB-type connection providing the first communications link between the symbiot and the I/O port of the host-PC.

8. The PC-to-TV Audio/Visual (A/V) link assembly of claim 1, wherein the A/V interface is integrated with the symbiot and the A/V interface includes a second interconnect cable means to accomplish the second communications link between the symbiot and the video display and sound system.

9. The PC-to-TV Audio/Visual (A/V) link assembly of claim 8, wherein the A/V interface of the symbiot comprises the second interconnect cable means having a connector selected from the group of connectors consisting of: a SCART connector, an optical S/PDIF, a stereo CINCH, an FP/dif coaxial, or optical connector to accomplish the second communications link between the symbiot and the video display and sound system.

10. The PC-to-TV Audio/Visual (A/V) link assembly of claim 1, wherein the PC-interface of the symbiot comprises:
a video conversion circuit receiving a conditioned video signal from the host-PC, the video conversion circuit adapted to convert the conditioned video signal as appropriate for communication to the A/V-interface; and
an audio processing circuit receiving a conditioned audio signal from the host-PC, the audio processing circuit functioning as an additional external sound card adapted to convert the conditioned audio signal as appropriate for communication to the A/V-interface

11. The PC-to-TV Audio/Visual (A/V) link assembly of claim 1, wherein the symbiot has a DVB-T receiver.

12. The PC-to-TV Audio/Visual (A/V) link assembly of claim 1, wherein the symbiot has a USB hub. $

13. The PC-to-TV Audio/Visual (A/V) link assembly of claim 1, wherein the symbiot has a media player interface adapted to receive inputs from a media player.

14. The PC-to-TV Audio/Visual (A/V) link assembly of claim 1, wherein the remote control user interface and the remote control receiver unit of the controller device are adapted to communicate via an RF signaling mechanism.

15. The PC-to-TV Audio/Visual (A/V) link assembly of claim 1, wherein the process application of the instruction set includes processes for searching the host-PC for a trace resident on the host-PC (e.g., a file, a flag, a driver, a registry entry, and application, etc.) of the video content distribution system, and a for establishing an Internet communication connection between host-PC and the video content distribution system.
